(19) United States
(12) Patent Application Publication
(10) Pub. No.: US 2021/0014719 A1
(43) Pub. Date: Jan. 14, 2021

(54) MULTI-NODE, MULTI-INTERFACE, HYBRID MESH NETWORK APPARATUS, SYSTEM, AND METHOD OF USE

(71) Applicants: Ha Nguyen, Irvine, CA (US); Giang Nguyen, Irvine, CA (US)

(72) Inventors: Ha Nguyen, Irvine, CA (US); Giang Nguyen, Irvine, CA (US)

(21) Appl. No.: 16/922,928

(22) Filed: Jul. 7, 2020

Related U.S. Application Data
(60) Provisional application No. 62/871,788, filed on Jul. 9, 2019.

(51) Int. Cl. H04W 28/02; H04W 84/18; H04L 12/18; H04W 40/12; H04W 4/06

(52) U.S. Cl. CPC H04W 28/021; H04W 84/18; H04W 4/06; H04L 12/1877; H04W 40/12; H04L 12/1854

(57) ABSTRACT

Embodiments of the present invention provide a mesh network having nodes connected via both wired and wireless connections, at differing data rates. Each node of the invention also has a plurality of interfaces and a backhaul network. The invention provides a method of managing the mesh network such that at least one node is capable of being in communication with a plurality of other nodes within the network and send and receive packets to other nodes without being hampered by differing protocols, standards, or data rates.

### CROSS-REFERENCE TO RELATED APPLICATIONS

This invention claims priority from the previously filed provisional application, U.S. Pat. No. 62/871,788, filed Jul. 9, 2019, the contents of which are hereby incorporated by reference.

### BRIEF DESCRIPTION OF THE INVENTION

The present invention relates to digital network architecture and management. Particularly, a mesh network having at least one node, a plurality of wired communication protocols, a plurality of wireless communication protocols, a plurality of interfaces, a backhaul, and method of managing the mesh network such that at least one node is capable of being in communication with a plurality of other nodes within the network.

In embodiments of the invention, the mesh network comprises a plurality of nodes, each node having multiple wireless interfaces as well as wired interfaces. The network further comprises network traffic classified by three types: high speed backhaul network traffic, high speed access network traffic, and Low-speed access network traffic.

The high-speed backhaul network can include Power Line Communication (PLC), Gigabit Ethernet, Optical Fiber, WiFi and LTE. The high-speed access network usually consists of PLC, WiFi, and Ethernet clients. The low speed access network typically includes ZigBee and/or Z-Wave networks. The backhaul network of the invention is configured to transport all network traffic within the network at high speed. Further, the backhaul network is configured to sufficiently adapt to node and traffic capacity, enabling heightened network fidelity and stability under stresses associated with scalability.

In another embodiment of the invention, the network comprises a Wireless and Powerline Network (WiPoN), having at least one node with a virtual address. Further, the at least one node comprises at least one interface, such as a WiFi interface, Zigbee interface, or a PLC interface. In most embodiments of the invention, the at least one interface may be identified by a specific address to identify the interface within the network.

In some embodiments of the invention, the WiPoN further comprises at least one hash function configured to convert a specific address of an interface to a virtual address of a given standard. Virtual address standards include but are not limited to Zigbee, WiFi, and PLC standards.

The methods, systems, and apparatuses are set forth in part in the description which follows, and in part will be obvious from the description, or can be learned by practice of the methods, apparatuses, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed. More details concerning these embodiments, and others, are further described in the following figures and detailed description set forth herein below.

### BRIEF DESCRIPTION OF THE DRAWINGS

FIG. 1 illustrates a mesh network having multiple communication protocols

FIG. 2 illustrates an embodiment of the invention having 5 nodes connected to the same phase of a power line.

FIG. 3 illustrates an embodiment of the invention having 7 nodes connected to different phases of a power line.

FIG. 4 illustrates a node of the invention having multiple interfaces.

FIG. 5 illustrates an exemplary neighbor node table of the invention.

FIG. 6 illustrates a flowchart of the process of sending an initiation packet for a node of the invention.

FIG. 7 illustrates a flowchart of the process of receiving and processing an initiation packet for a node of the invention.

FIG. 8 illustrates a flowchart of the process of sending a data packet for a node of the invention.

FIG. 9 illustrates a flowchart of the process of receiving and processing a data packet for a node of the invention.

FIG. 10 illustrates an embodiment of the invention in which a data packet is sent via an interface with low data rate.

FIG. 11 illustrates a plurality of neighbor node tables corresponding to an embodiment of the invention shown in FIG. 10.

FIG. 12 illustrates an embodiment of the invention in which a data packet is sent via an interface with high data rate.

FIG. 13 illustrates a plurality of neighbor node tables corresponding to an embodiment of the invention shown in FIG. 12.

### DETAILED DESCRIPTION OF THE INVENTION

The present invention relates to digital network architecture and management. Particularly, a mesh network having at least one node, a plurality of wired communication protocols, a plurality of wireless communication protocols, a plurality of interfaces, a backhaul, and method of managing the mesh network such that at least one node is capable of being in communication with a plurality of other nodes within the network.

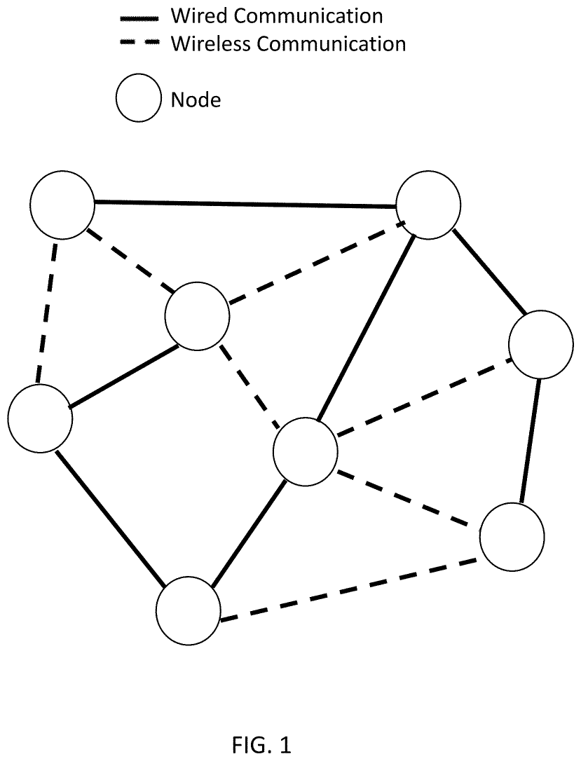

FIG. 1 illustrates an example of a mesh network consisting of multiple devices, or nodes, having multiple wireless interfaces and wired interfaces. In embodiments of the present invention, the mesh network comprises a plurality of nodes, each node having multiple wireless interfaces as well as multiple wired interfaces. The network further comprises network traffic classified by three types: high-speed backhaul network traffic, high-speed access network traffic, and low-speed access network traffic.

The high-speed backhaul network may comprise Power Line Communication (PLC), Gigabit Ethernet, Optical Fiber, WiFi and LTE. The high-speed access network usually consists of PLC, WiFi, and Ethernet clients. The low-speed access network typically includes ZigBee and/or Z-Wave networks. The backhaul network of the invention is configured to transport all network traffic within the network at high speed. Further, the backhaul network is configured to sufficiently adapt to node and traffic capacity, enabling heightened network fidelity and stability under stresses associated with scalability.

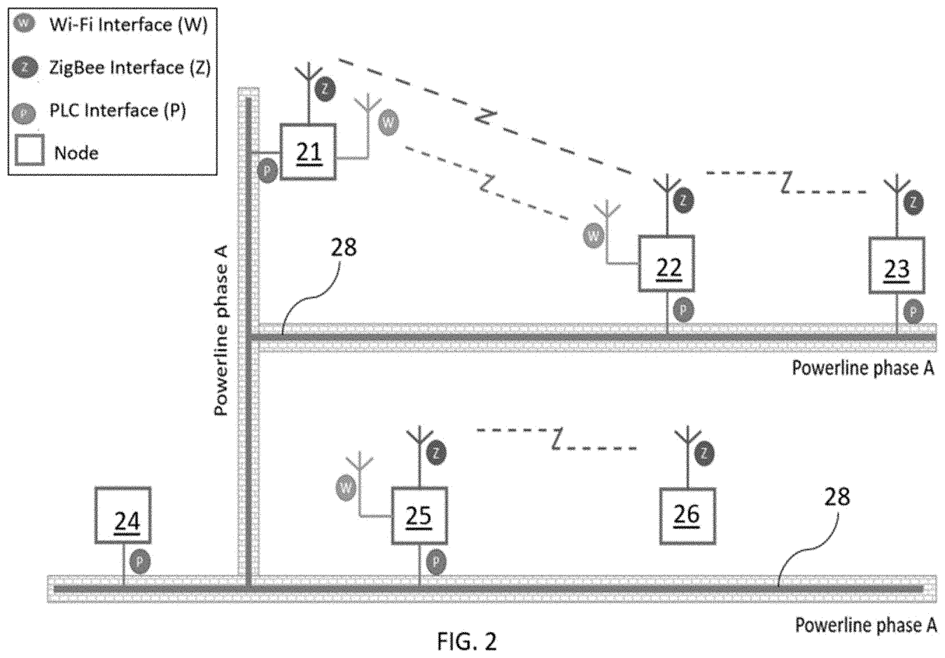

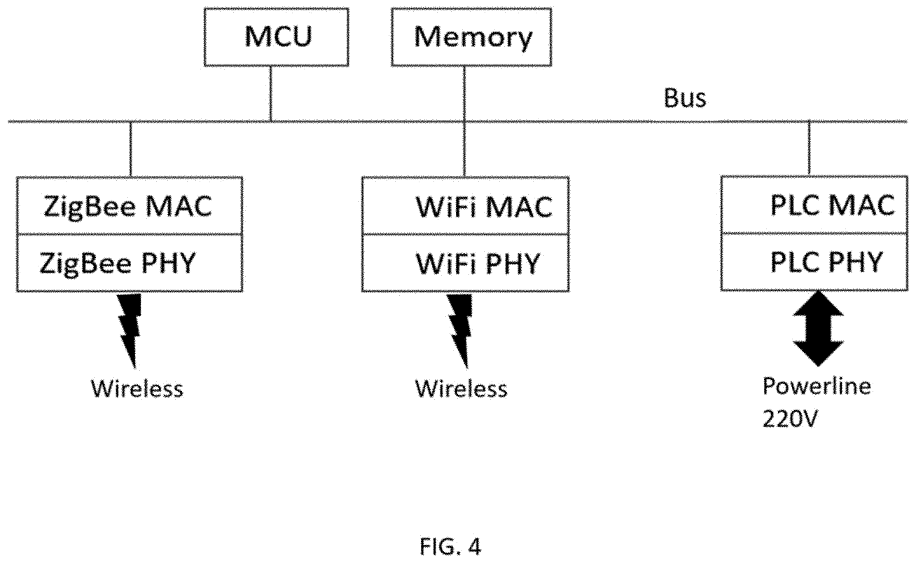

FIG. 2 illustrates an embodiment of a Wireless and Powerline Network (WiPoN) of the invention, having multiple nodes connected to a same phase of a powerline. Here, five nodes are working in the same phase of the powerline phase A 28: a first node 21, a second node 22, a third node 23, a fourth node 24 and a fifth node 25. The WiPoN also includes a sixth node 26. A node comprises at least one interface. In this example, the fourth node 24 and the sixth node 26 have one interface each. The third node 23 has two interfaces. The first node 21, second node 22, and fifth node 25 have three interfaces each. FIG. 4 further illustrates a node of the invention having multiple interfaces. The at least one interface may comprise a ZigBee interface, a WiFi interface, a PLC interface, or another interface known in the art. A WiPoN having multiple nodes is not limited to five nodes connected to the same phase of a powerline, in other embodiments there may be more or less than five nodes.

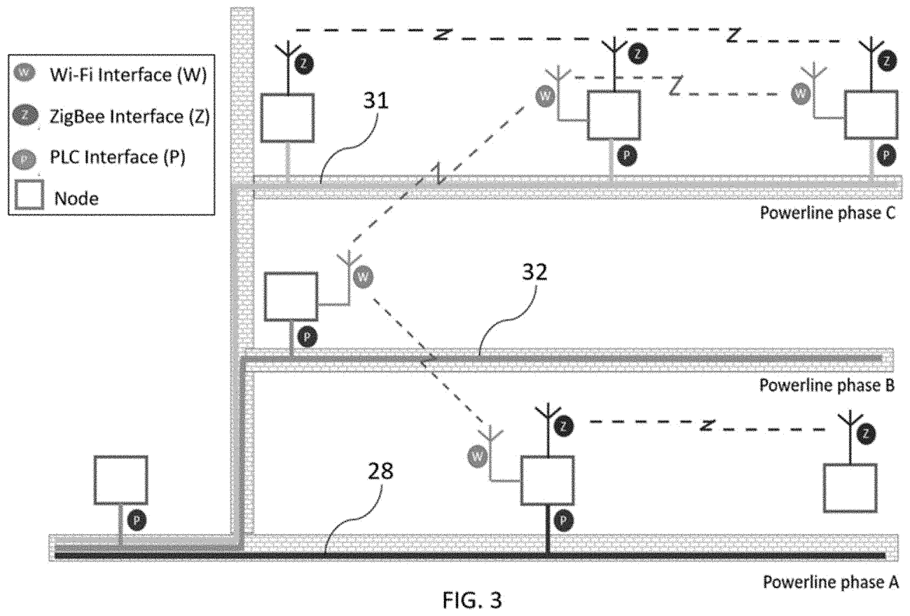

FIG. 3 illustrates another embodiment of the invention having seven nodes connected to different phases of a power line. In this example, the power line comprises three phases: powerline phase A 28, powerline phase B 32, and powerline phase C 31. One node is connected to the powerline phase A 28. Two nodes are connected to the powerline phase B 32. Three nodes are connected to the powerline phase C 31.

In another embodiment of the invention, the network comprises a WiPoN, having at least one node with a virtual address. Further, the at least one node comprises at least one interface, such as a WiFi interface, Zigbee interface, or a PLC interface. In most embodiments of the invention, the at least one interface may be identified by a specific, or MAC, address to identify the interface within the network.

In some embodiments of the invention, the WiPoN further comprises at least one hash function configured to convert a specific address of an interface to a virtual address of a given standard. Virtual address standards include but are not limited to Zigbee, WiFi, and PLC standards.

When generating an address corresponding to each node of the invention, first a unique flat address is generated after booting, referred to as Node_ID. The Node_ID can be derived from at least one MAC address of a node using at least one Hash function. The Node_ID can be considered as a virtual address in WiPON:

Node_ID=WiPoN virtual address=Hash_function(MAC_W, MAC_Z, MAC_P)

When joining a network (WiFi, ZigBee or PLC), each node broadcasts an initiation packet to communicate initial connection. The initiation packet comprises: a sequence configured to eliminate message duplicates, and a WiPoN virtual address, denoted as Node_ID. The initiation packet is broadcasted periodically to support the monitoring of a node. Because both PLC and Wireless networks share a broadcast medium, if a node sends an initiation packet, other nodes within a communication range may receive this message as well. Each node can then detect initiation packets coming from at least one neighbor node via a specific interface (Wifi, ZigBee, or PLC).

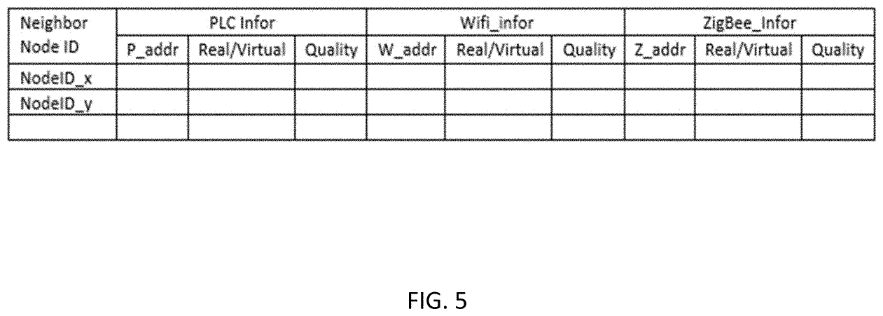

Each node has a neighbor node table, as shown in FIG. 5, comprising a plurality of data points, including Neighbor Node_ID, P_addr, W_addr, Z_addr, Real address, Virtual address, and Quality indicators. Neighbor Node_ID refers to the virtual address of the neighbor node, from which the current node can receives Initiation packets. P_addr, W_addr, and Z_addr each refer to a MAC address of a given interface of a neighbor node, PLC, Wifi, and ZigBee, respectively. Real address and Virtual address refer to the Real MAC address or Virtual MAC address. The Real MAC will be assigned by a given manufacturer of a node device and can be used to send a packet to that corresponding interface; the Virtual MAC address is generated for the purposes of identification within the table, as in FIG. 5. Quality refers to a link quality of the specific interface. The quality value is determined from a plurality of PHY metrics including but not limited to signal strength, PHY data rate, and bit error rate. Each interface comprises at least one of the plurality of PHY metrics. The quality value may be estimated continuously when a node receives a Initiation packet:

Quality=A·f(PHY Metric 1)+B·g(PHY Metric 2)+C·h(PHY Metric 3)

In which A, B and C are coefficients, and f(PHY Metric 1), g(PHY Metric 2), h(PHY Metric 3) are the objective functions for each given metric.

A WiPoN node may not have all PHY interfaces (e.g. all PLC, WiFi and ZigBee). Hence, if one neighbor node is lacking of an interface, when the current node receives a Initiation packet from the neighbor via 1 available interface (e.g. Z interface), a corresponding MAC of the interface (which current node has, e.g. W interface) is created virtually (for example by using Hash function). This virtual MAC is used to announce the neighbor (with only Z interface) to other interfaces of the current node in WiPoN.

When receiving an Initiation packet from a neighbor, a node will check whether this neighbor node exists in the table or not. If this neighbor does not exist, the node will create an entry for this neighbor with the all the corresponding information. Otherwise, the node will calculate and update the quality field only. After that, the node will rebroadcast the Initiation packet with a random back-off time to avoid collisions.

However, if a node cannot detect Initiation packets from a specific neighbor node interface, for a specific duration the node will mark the neighbor node interface as invalid and default to not connect with the neighbor node interface. A neighbor node having all invalid interfaces will be viewed by all nodes as exiting the WiPoN, and will be removed from the neighbor node table of each node to save memory for neighbor nodes.

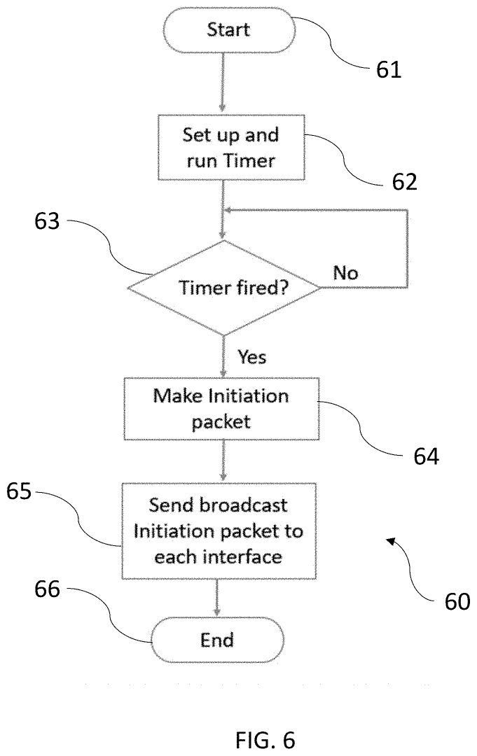

FIG. 6 illustrates a flowchart 60 of a process of sending an initiation packet for a node of the invention. At a first step 61 the process is initiated. Next, at step 62, the node commences a run timer. At step 63 the node checks if the timer has fired or ended. If the timer has not ended, the process repeats step 63. If the time has fired, the process proceeds to step 64. At step 64, the node generates an initiation packet. At step 65, the node sends a broadcast initiation packet to each interface of the node. The process ends at step 66.

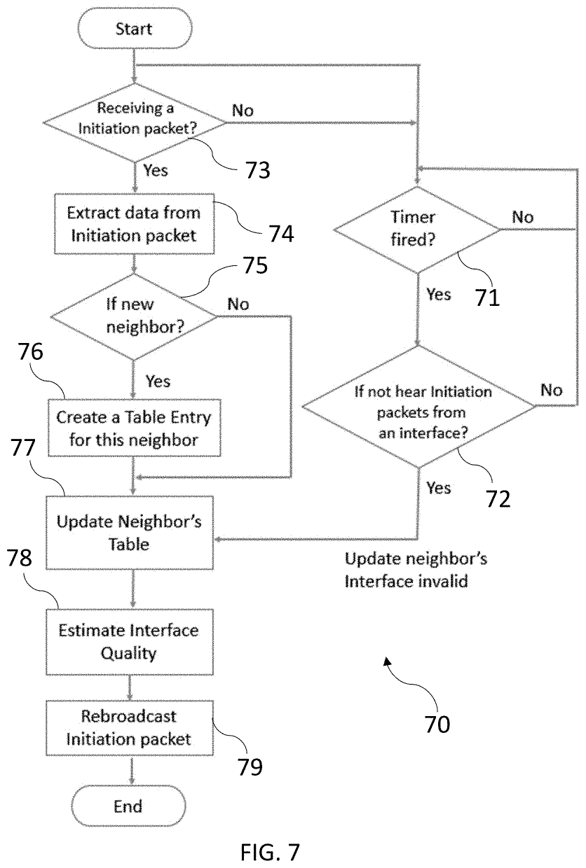

FIG. 7 illustrates a flowchart 70 of a process of receiving an initiation packet from at least one neighbor node at an initial node. The initial node commences a timer, at a first step 71 the initial node checks whether the timer has fired. Each neighbor node comprises a timer to query the status of other neighbor nodes. The process also proceeds to step 73 and determines if an initiation packet is received from a neighbor node. If an initiation packet is not received, the process proceeds to step 71. If the timer has not fired, the process repeats step 71.

If the timer has fired, the process proceeds to step 72. At step 72, the node determines if it received an initiation packet. If no initiation packet is received, the node marks the neighbor node as invalid and proceeds to step 77. At step 77, the node updates the neighbor node table to mark the neighbor node as invalid, further described above.

If an initiation packet is received at step 73, the process proceeds to step 74. Next, at step 74 the node extracts data from the initiation packet and determines a source of the initiation packet. Then the node compares the source to the neighbor node table at step 75, if the neighbor node is new and not found in the neighbor node table, the process proceeds to step 76. At step 76, a table entry is created in the neighbor node table for the new neighbor node and the process proceeds to step 77. If the neighbor node is already known, the process proceeds to step 77. At step 77, the neighbor node table is updated to either include new or updated information about a known neighbor node, such as the quality value, or enter new information for a new neighbor node corresponding to the neighbor node table. FIG. 5 illustrates an exemplary neighbor node table of the invention. Proceeding to step 78, an interface quality value is generated. Finally, at step 79, the node rebroadcasts the initiation packet.

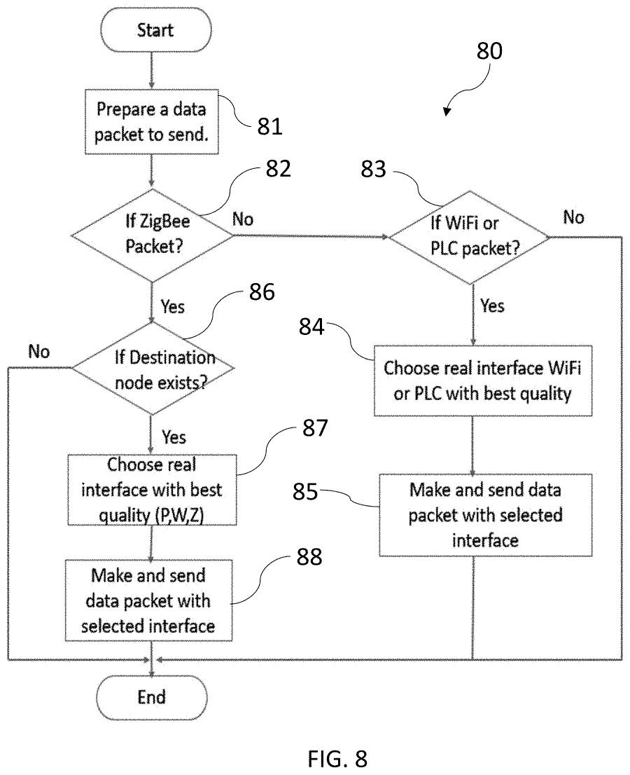

FIG. 8 illustrates a flowchart 80 of the process for a node sending a data packet. At a first step 81, the packet is prepared. Next at step 82 and step 83, the standard applicable to the packet is determined. If the standard is ZigBee, the process proceeds to step 86. If the standard is WiFi or PLC, the process proceeds to step 84. At step 84, a neighbor node table is queried and information is retrieved on an interface with highest relative quality. Then at step 85, the packet is sent with the interface having the highest relative quality.

If the destination node exists in the neighbor node table, the process proceeds from step 86 to step 87. At step 87, the neighbor node table is queried, and information is retrieved on an interface with highest relative quality. Then at step 88, the packet is sent with the interface having the highest relative quality.

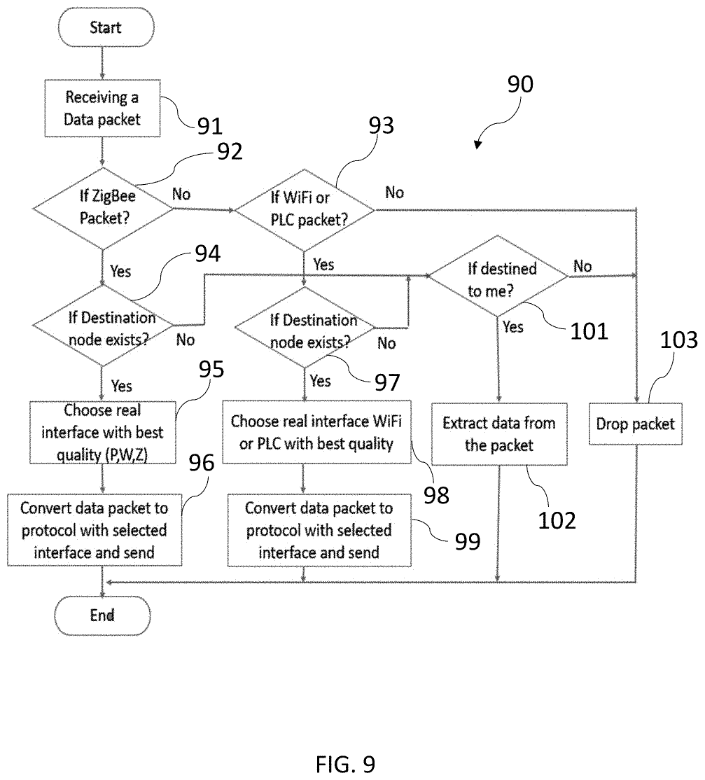

FIG. 9 illustrates a flowchart 90 of the process of sending a data packet for a node of the invention. At a first step 91, the data packet is prepared. Next, the standard applicable to the packet is determined. At step 92, if the packet uses a ZigBee standard, the process proceeds to step 94. At step 94, the intended destination node of the packet is determined. If a destination node of the packet exists in the neighbor node table, the process proceeds to step 95. If a destination node does not exist in the neighbor node table, the process proceeds to step 101. At step 95, data from the packet is extracted and the interface with the best quality is selected. The node queries a neighbor node table to retrieve information on an interface with highest relative quality value. Next, at step 96 the selected interface is applied to the packet and extracted data from the packet is converted using the selected interface. The node sends the converted packet.

If the packet does not use a ZigBee standard, the process proceeds to step 93. At step 93, if the packet does not use a WiFi or PLC standard, the process proceeds to step 103. If the packet does use a WiFi or PLC standard, the process proceeds to step 97. At step 97, the intended destination node of the packet is determined. If a destination node exists in the neighbor node table, the process proceeds to step 98. If a destination node does not exist in the neighbor node table the process proceeds to step 101. Next at step 98, data from the packet is extracted and the interface with the best quality is selected. The node queries a neighbor node table to retrieve information on an interface with highest relative quality value. At step 99, the selected interface is applied to the packet and extracted data from the packet is converted using the selected interface. The node sends the converted packet.

At step 101, if the node is not the intended destination, the process proceeds to step 103. Next at step 103, the node drops the packet and the process ends. If the node is the intended destination of the packet, the process proceeds to step 102 and data from the packet is extracted.

### Example 1

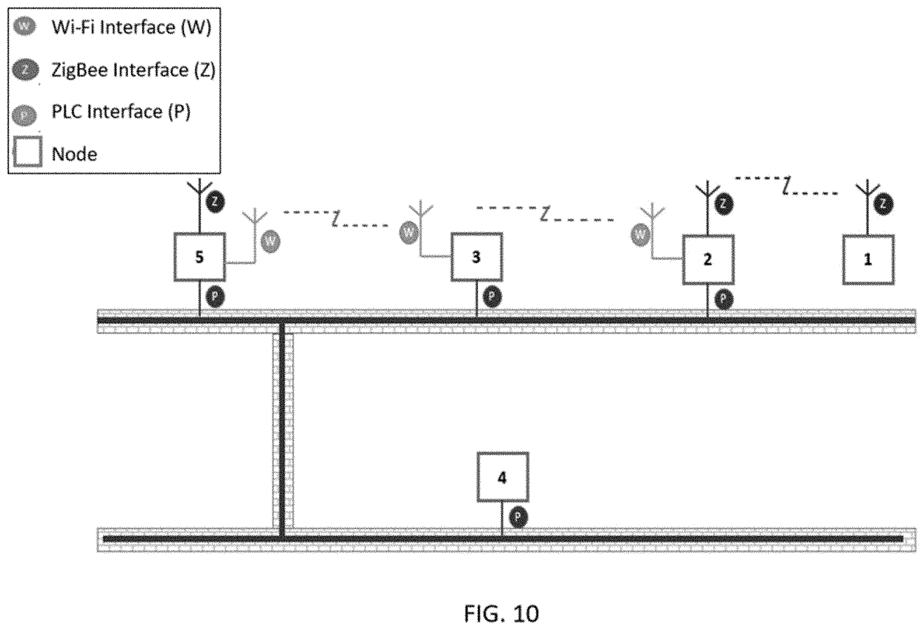

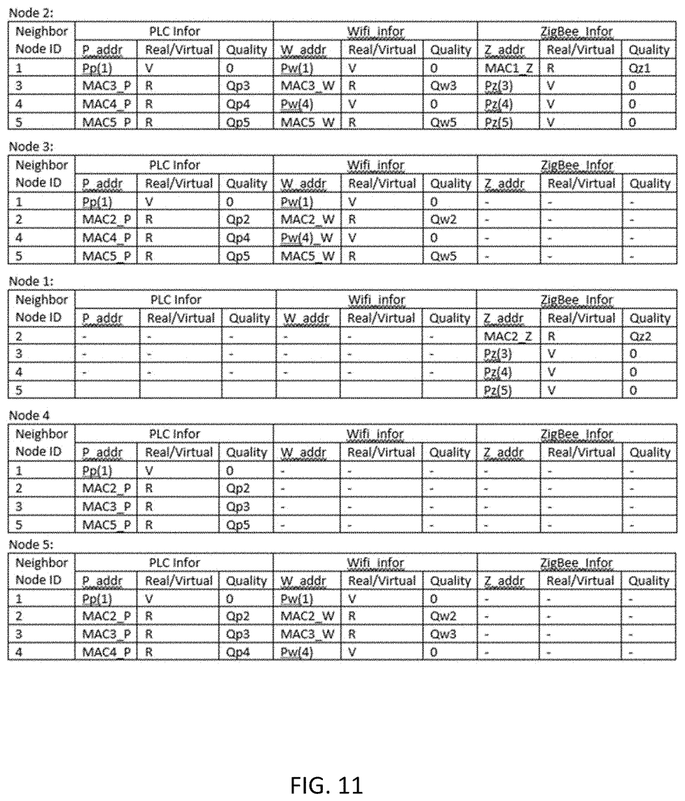

FIG. 10 shows a WiPoN configuration in which a data packet is sent via an interface having a low-data rate. Assuming node 1 joins the WiPoN, it broadcasts an initiation packet. Node 2 receives the packet via a ZigBee interface. Similarly, node 2 will get all initiation packets from other nodes (node 3, 5 via W interface, node 3, 4, 5 via P interface) to build the full table, as shown in FIG. 11. Note that the ZigBee interface of node 5 does not have information for node 1 due to the ZigBee interface of node 1 being isolated.

Where node 1 sends a packet to node 4, the following is transmitted to node 2:

Src ZigBee Addr: MAC1_Z

Dst ZigBee Addr: Pz(4)

Node 2 then queries the neighbor node table to retrieve the indication that node 2 can reach node 4 via only a PLC interface. Therefore, node 2 converts the packet to PLC protocol:

Src PLC addr: MAC2_P

Dst PLC addr: MAC4_P (corresponding to Pz(4) virtual address)

Where node 1 sends a packet to node 5, the following is transmitted to node 5:

Src ZigBee Addr: MAC1_Z

Dst ZigBee Addr: Pz(5)

Note that node 5 also has a real ZigBee interface (real MAC5_Z) but node 1 cannot retrieve this information because the ZigBee coverage of node 5 cannot be reached by node 2 or node 1. Node 2 then queries the neighbor node table to retrieve the indication that node 5 via both PLC and WiFi interfaces. Hence, it then queries the neighbor node table again to retrieve the indication of which interface has better quality to forward the packet. Assuming WiFi is better (Qw5>Qp5), node 2 converts the packet to a WiFi packet:

Src WiFi addr: MAC2_W

Dst WiFi addr: MAC5_W

This packet is then sent to node 3 (within communication range) and node 3 queries the neighbor node table to retrieve the indication that two paths to node 5 are accessible (via PLC and WiFi, real MAC). Node 3 then queries the neighbor node table again to retrieve the indication of the better link (e.g. PLC is better Qp5>Qw5), and then converts the packet to PLC protocol:

Src PLC addr: MAC3_P

Dst PLC addr: MAC5_P

### Example 2

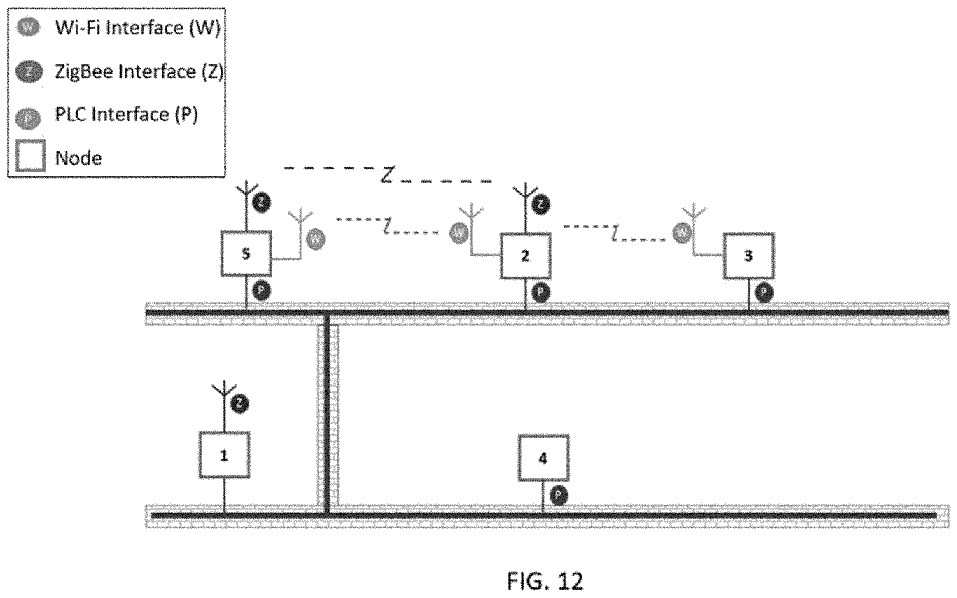

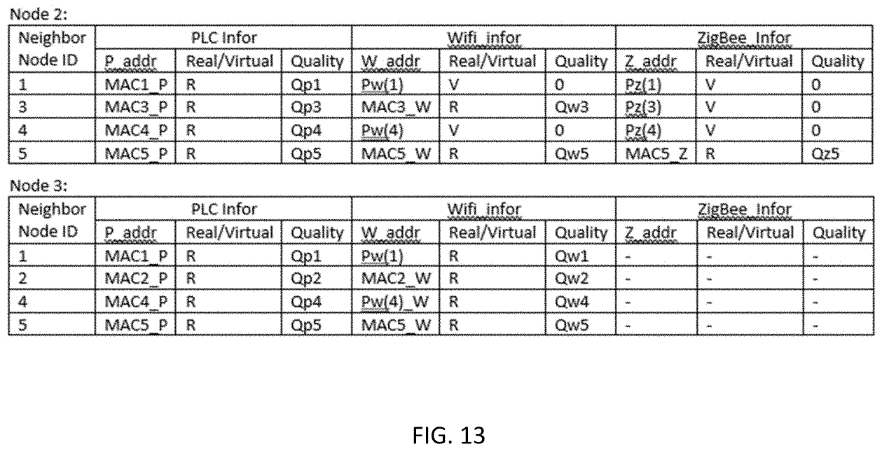

FIG. 12 shows a WiPoN configuration in which a data packet is sent via an interface having a high data rate. The neighbor node tables are as shown in FIG. 13. Node 3 sends a packet to node 5. Assuming that within the neighbor node table of node 3, the WiFi quality to node 5 is better than PLC quality (Qw5>Qp5), node 3 then sends the WiFi packet to node 5 using the following:

Src WiFi MAC: MAC3_W

Dst WiFi MAC: MAC5_W

The packet is sent to node 2 (in communication range). Node 2 checks its table and sees 3 paths to node 5 (real MAC addresses of ZigBee, PLC and WiFi). However, because this is the WiFi packet (high data rate) so it cannot use ZigBee interface to forward the packet. Therefore, node 2 chooses PLC or WiFi to forward the incoming WiFi packet. Assuming PLC interface has better link quality (Qp5>Qw5), then node 2 makes the PLC packet with the following addresses:

Src PLC MAC: MAC2_P

Dst PLC MAC: MAC5_P

Those of ordinary skill in the art will understand and appreciate that the foregoing description of the invention has been made with reference to certain exemplary embodiments of the invention, which describe a mesh network having at least one node, a plurality of wired communication protocols, a plurality of wireless communication protocols, a plurality of interfaces, a backhaul, and a method of managing the mesh network such that at least one node is capable of being in communication with a plurality of other nodes within the network. Those of skill in the art will understand that obvious variations in system configuration, protocols, parameters or properties may be made without departing from the scope of the invention which is intended to be limited only by the claims appended hereto.

What is claimed is:

1. A system for transmitting a data packet to a node comprising:
a.) a mesh network, wherein the mesh network includes a plurality of nodes;
b.) a data packet, wherein the data packet includes a destination address;
c.) a first node, wherein the first node broadcasts the data packet, wherein the first node includes at least one network interface, wherein the first node includes at least one of a wired connection and a wireless connection;
d.) at least one neighbor node, wherein the neighbor node receives the data packet, wherein the neighbor node includes at least one network interface, wherein the neighbor node includes at least one of a wired connection and a wireless connection, wherein the neighbor node includes a neighbor node address, wherein the neighbor node compares the destination address to the neighbor node address;
e.) if the neighbor node address is not the same as the destination address, the neighbor node broadcasts the data packet; and
f.) if the neighbor node address is the same as the destination address, the neighbor node extracts data from the data packet.

2. The system of claim 1, wherein the network interface is a WiFi interface.

3. The system of claim 1, wherein the network interface is a power line control interface.

4. The system of claim 1, wherein the network interface is a ZigBee interface.

5. The system of claim 1, wherein the first node includes a plurality of network interfaces.

6. The system of claim 1, wherein the neighbor node includes a plurality of network interfaces.

7. The system of claim 1, wherein the neighbor node includes a neighbor node table, the neighbor node table having at least one node address, and wherein the neighbor node table is queried for the destination address.

8. The system of claim 7, wherein if the destination address does not exist in said neighbor node table, said neighbor node drops said data packet.

9. The system of claim 7, wherein the neighbor node table includes the destination address and an interface standard associated with the destination address, wherein the neighbor node broadcasts the data packet using the interface standard associated with the destination address if the neighbor node address is not the same as the destination address.

10. The system of claim 9, wherein the neighbor node table further includes a plurality of interface standards associated with the destination address and a quality value for each of the plurality of interface standards, wherein the neighbor node broadcasts the data packet using an interface standard having the highest quality value.

11. A method of transmitting a data packet to a node, the method comprising the following steps:
a.) preparing a data packet at a first node, wherein the first node includes a node table, wherein the first node includes a network interface, wherein the first node includes at least one of a wired connection and a wireless connection, wherein the data packet includes a destination address;
b.) requesting interface data corresponding to the destination address from the node table, wherein the node table includes a plurality of data points, including the destination address and interface data, wherein the interface data includes at least one interface standard and a quality value associated with each interface standard;
c.) comparing the quality value for each interface standard and determining the interface standard with the highest quality value;
d.) broadcasting the data packet from the first node using the interface standard with the highest quality value;
e.) receiving the data packet at a destination node, wherein the destination node is associated with the destination address; and
f.) extracting data from the data packet.

12. The method of claim 11, further comprising:
a.) receiving the data packet at a neighbor node, wherein the neighbor node includes a network interface, wherein the neighbor node includes at least one of a wired connection and a wireless connection;
b.) requesting the interface data corresponding to the destination address from a neighbor node table, wherein the neighbor node includes the neighbor node table, wherein the neighbor node table includes a plurality of data points, including the destination address and interface data, wherein the interface data includes at least one interface standard and a quality value associated with each interface standard
c.) comparing the quality value for each interface standard and determining the interface standard with the highest quality value;
d.) broadcasting the data packet from the neighbor node using the interface standard having the highest quality value; and
e.) receiving the data packet at a destination node, wherein the address of the destination node is the destination address.

13. The method of claim 12, further comprising: dropping the data packet if the destination address does not exist in the second node table.

14. The method of claim 11, further comprising the following steps:
a.) receiving the data packet at a second neighbor node, wherein the second node includes a second neighbor node table;
b.) requesting interface data corresponding to the destination address from the second neighbor node table, wherein the second neighbor node table includes a plurality of data points, including at least one interface standard and quality value associated with each interface standard;
c.) comparing the quality value for each interface standard and determining the interface standard with the highest quality value; and
d.) broadcasting the data packet from the second neighbor node using the interface standard having the highest quality value.

15. The method of claim 12, wherein the neighbor node drops the data packet when the neighbor node table does not include the destination address.
